(19) United States
(12) Patent Application Publication
(10) Pub. No.: US 2009/0202181 A1
(43) Pub. Date: Aug. 13, 2009

(54) PLASTIC BAG WITH GUSSETS FOR FOOD PRODUCTS AND ITS METHOD OF MANUFACTURE

(75) Inventor: Patrick Alaux, Unieux (FR)

Correspondence Address: HESLIN ROTHENBERG FARLEY & MESITI PC, 5 COLUMBIA CIRCLE, ALBANY, NY, 12203, US

(73) Assignee: VERIPLAST FLEXIBLE, Montfaucon en Velay (FR)

(21) Appl. No.: 12/305,980

(22) PCT Filed: Jul. 2, 2007
(86) PCT No.: PCT/FR07/51578

§ 371 Date: Dec. 22, 2008

(30) Foreign Application Priority Data
Jul. 3, 2006 (FR) 0652778

(51) Int. Cl. B65D 33/10; B65D 33/02; B65D 30/20; B31B 49/00; B31B 21/26

(52) U.S. Cl. 383/7; 383/119; 383/120; 493/267; 493/254

(57) ABSTRACT

Gussets are formed in longitudinal edges of a bag and result from two internal folds that are formed from a central line and connect, via connecting regions, the front face and rear face of the bag. At least one of the gussets has arrangements acting as a handle, and being continued, all the way along its length and at the regions of connection to the front and rear faces, by a part so shaped as to act as a sheath capable of receiving internally an element forming the handle.

The invention relates to the technical field of plastic bags, in particular like those intended to accommodate food for animals, in the form of granules for example.

In general, in a manner perfectly known to a person skilled in the art, these types of bag have gussets suitable in particular for increasing the capacity of the bag. These gussets are formed at the longitudinal sides of the bag, between two walls constituting the front and back of the bag. These gussets are commonly made along the whole height of the bag.

Various technical solutions can be used for the continuous production of this type of bag. For example, advantageously, the bags are produced from a roll of plastic film which is continuously unwound. For example, the plastic film is subjected to operations for bounding, between its two longitudinal edges, a portion intended to constitute the front of the bag, a portion intended to constitute one of the gussets, a portion intended to constitute the back of the bag and a portion intended to constitute the other gusset. The film is then subjected to various operations of successive bendings, cutting and welding, to produce a bag with gussets with a bottom and generally a filling opening.

Furthermore, regardless of the embodiment, the upper portion of the bag, opposite the bottom, commonly has, above a sealed closure zone, arrangements constituting a handle.

Since these bags have a height that is much greater than the width, difficulties may arise in lifting and carrying the bag. This is because the handle, particularly in the case of large capacity bags, is located at such a distance from the ground that it is necessary, particularly for a short person, to make considerable efforts in order to lift and detach the bottom of the bag from the ground.

To try to remedy these drawbacks, it has been proposed to provide arrangements to serve as a handle, no longer at the upper horizontal side of the bag, but substantially at the median portion of one of the gusset sides of the bag, in order to carry it in a horizontal rather than a vertical position. Such a positioning of the handle enables the carrier to guide the bag with its largest dimension (corresponding to its height) horizontally, thereby reducing the vertical dimension of the bag, and accordingly requiring a considerably reduced effort to lift it from the ground.

Various technical solutions have been proposed to perform this function.

For example, one solution appears from the teaching of patent FR 2 791 040, whereof the present Applicant is also the proprietor.

According to the teaching of this patent, a handle, disposed substantially at mid-length of one of the longitudinal gusset sides of the bag, consists of a strip of heat-sealable material on the bag. The length of the strip is equal to the transverse developed length of the gusset plus the length of two end flaps fixed by welding to the corresponding outer sides of the gusset concerned. This solution requires the use of materials based on a heat-sealable plastic, in order to fasten the handle in the form of an added handle.

Another solution appears from the teaching of document WO/02/074646, where a handle is produced from an opening made in a portion that prolongs each of the folds of one of the gussets. In concrete terms, one of the gussets of the bag has folds which are at least twice as long as the length of the folds of the other gusset. A weld formed at a predefined distance from the crease of the two very long folds, serves to produce identical gussets on each side, one of which, along its whole length, has a free strip in which the handle can be formed. This embodiment thus needlessly increases the width of the bag having a given capacity, and obviously demands surplus material, thereby significantly increasing the manufacturing costs.

It is the object of the invention to remedy these drawbacks simply, safely, effectively and efficiently.

The problem that the invention proposes to solve is to produce a handle at the longitudinal gussets of a plastic bag, in particular with an outer layer of PET, by means of a conventional continuous bag production method, and in which the gussets have the same dimensions on each side, with the requirement of maintaining a seal inside the bag. It should be observed that PET is unfit for welding.

To solve such a problem, a plastic bag with gussets for food products has been designed and developed, the gussets being formed at the longitudinal sides of the bag and resulting from two internal folds and formed from a median line and connecting, via connecting zones, the front and the back of the said bag. At least one of the said gussets has arrangements serving as a handle.

According to the invention, the arrangements are formed at the two internal folds of at least one of the gussets, in combination with an added element fixed between the connecting zones of the said folds with the front and back.

In view of these features, it therefore appears that the arrangements serving as a handle are formed inside the zone bounded by the folds of the gusset.

Based on this concept, various embodiments can be provided to produce the arrangements serving as a handle.

In a first embodiment, the arrangements consist of openings formed in the thickness of the folds of the gusset, substantially at mid-length of the said gusset and, facing the added element which is fixed to the interior of the folds of the gusset, in a sealed manner. The openings have a generally substantially oblong shape and are disposed symmetrically, on either side of the median line of the two folds, while bounding a central strip that constitutes the handle as such, after having introduced a hand through the said openings.

In this embodiment, to solve the problem of facilitating the formation of the handle, profiled slits may be formed transversally in the thickness of the folds of the gusset, facing the added element, and on either side of the openings.

In another embodiment, the arrangements consist of profiled slits formed in the thickness of the folds of the gusset, facing the added element which is fixed inside the folds of the gusset, in a sealed manner, the said slits being disposed symmetrically, on either side of the median line of the two folds, while bounding a central strip that constitutes the handle as such after having introduced a hand through the said slits.

In these two embodiments, it appears that the handle as such is produced directly from the material of the bag.

In order to reinforce the handle thus formed, a reinforcing strip is provided to be added on and fixed inside the folds of the gusset, facing the added seal element, the openings and/or slits also being formed in the thickness of this strip.

In another embodiment, the arrangement consists of slits or openings formed in the thickness of the added element which is fixed outside the folds of the gusset, substantially at mid-length of the said gusset. The slits or openings are formed symmetrically on either side of the median line of the added element, while bounding a central strip that constitutes the handle as such, after having introduced a hand through the said slits or openings.

In this other embodiment, to enable the added element to constitute the handle as such, this added element is fixed at the longitudinal sides only, close to the connecting zones of the folds of the gusset with the front and back.

Regardless of the embodiment considered, the added element has a substantially quadrangular planar shape.

More particularly, when the handle is made from openings or slits formed in the folds of the gusset concerned, the added element has a substantially quadrangular planar shape dimensioned to completely cover the openings or slits in order to create a seal inside the bag.

The invention also relates to the manufacturing method for the production of the bag, of which at least one of the longitudinal sides has gussets with arrangements serving as a handle.

According to the invention, the method comprises the following essential steps:
a roll of plastic film is unwound continuously, and subjected to operations to bound, between the two longitudinal edges of the film, a portion constituting the front of the bag, a portion constituting one of the gussets, a portion constituting the back of the bag, another portion constituting the other gusset;
at regular intervals, one of the portions constituting one of the gussets, is continuously subjected to at least one operation for making arrangements to serve as a handle;
the film is subjected to various operations of bending, cutting and welding, to produce a bag having a bottom, longitudinal sides with gussets and an opening.

The invention is described in greater detail below in conjunction with the figures of the appended drawings in which:

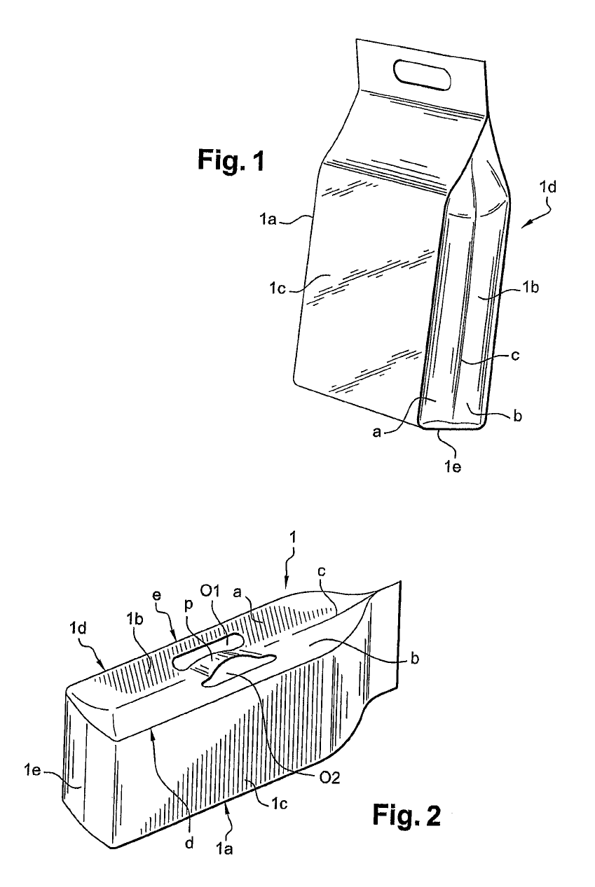

FIG. 1 is a perspective view of a bag with gussets according to the prior art, that is, with a handle formed at the upper edge of the bag;

FIG. 2 is a perspective view of an identical bag to the one in FIG. 1, but whereof one of the longitudinal gusset sides is arranged according to the invention to constitute a handle;

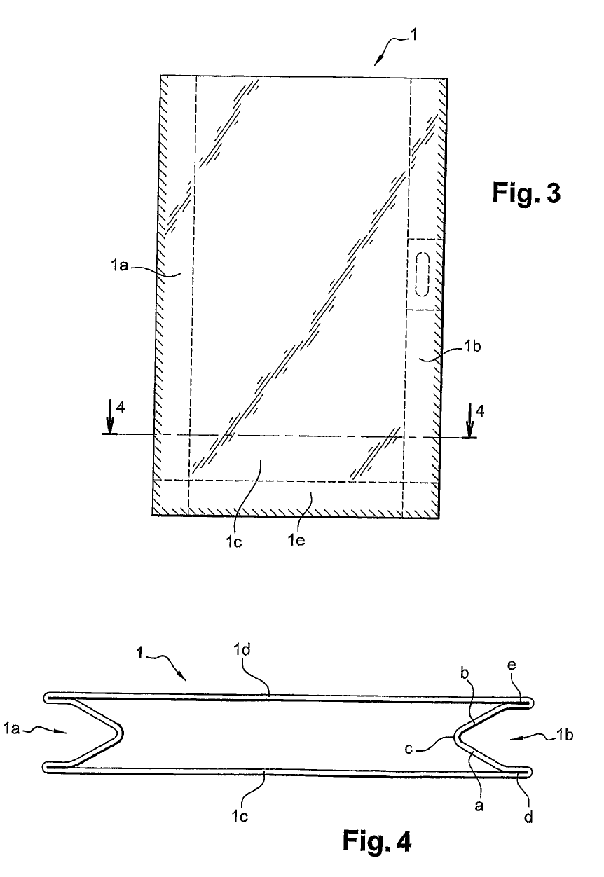

FIG. 3 is a schematic front view of the bag according to the invention;

FIG. 4 shows a cross section along 4-4 in FIG. 3;

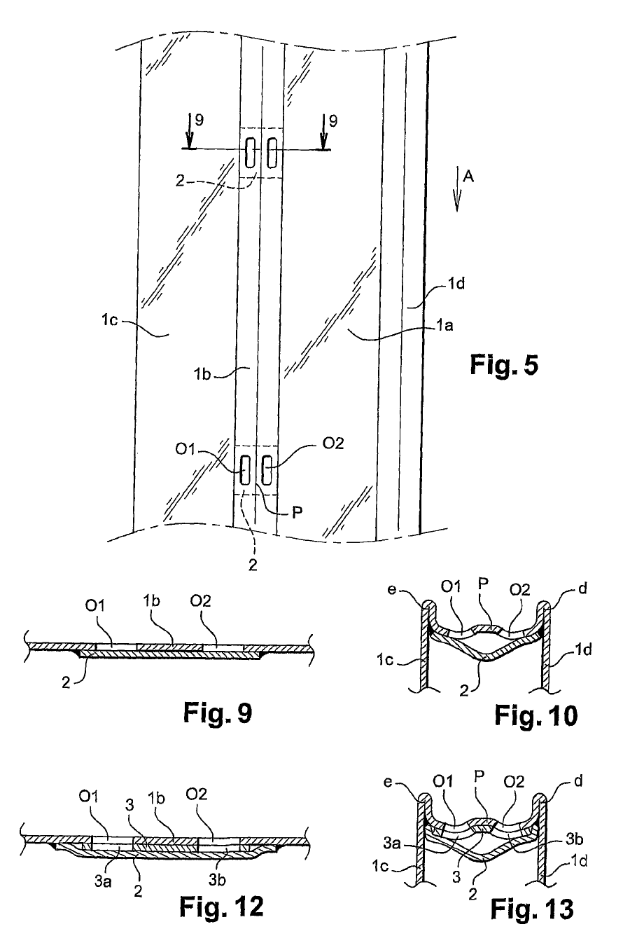

FIGS. 5, 6, 7 and 8 are plan views showing a part of the method for manufacturing the bag from a continuous plastic film for producing arrangements serving as a handle at the portion of the film intended to constitute one of the gussets, these figures showing various embodiments of the arrangements, to constitute the handle;

FIG. 9 shows a cross section along 9-9 in FIG. 5, the thicknesses having been deliberately exaggerated for a clearer understanding of the drawings;

FIG. 10 is a view similar to FIG. 9 showing the formation of the handle;

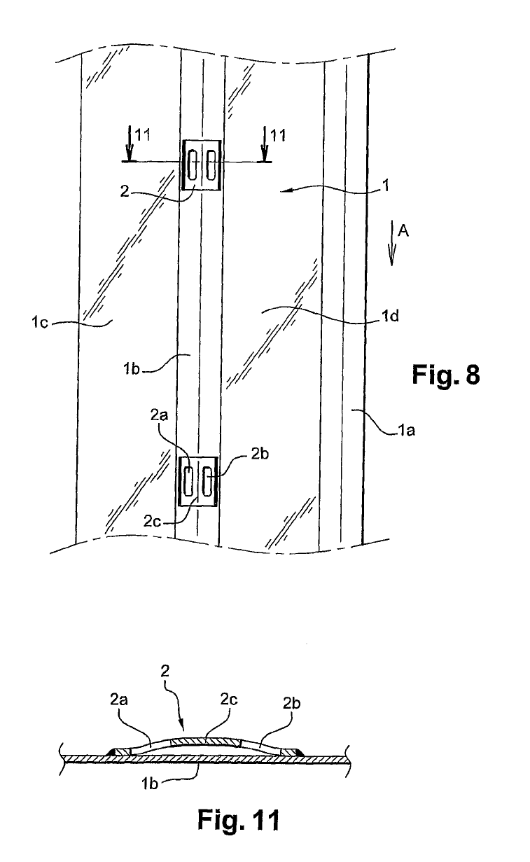

FIG. 11 shows a cross section along 11-11 in FIG. 8, the thicknesses having been deliberately exaggerated;

FIGS. 12 and 13 are views similar to FIGS. 9 and 10 of an embodiment with addition of a reinforcing strip at the handle.

As stated above, in a manner perfectly known to a person skilled in the art, the bag with gussets according to the invention is obtained from a plastic film (1) which is subjected to successive bending operations to produce longitudinal gussets (1a) and (1b) between two walls (1c) and (1d) constituting the front and back of the bag. These arrangements are perfectly known to a person skilled in the art and are not described in detail. The same applies concerning the production of a bottom (1e) which may result from a welded joint at the bottom end of the two walls (1c) and (1d) and a flap on one of the walls (1c) or (1d).

It is also recalled, in a manner known per se, that each gusset (1a) and (1b) results from two internal folds (a) and (b) formed from a median line (c). The folds (a) and (b) connect the front (1c) and the back (1d) of the bag by connecting zones (d) and (e). It may be observed that a weld can be executed at the connecting zones (d) and (e) in order to correctly form the folds as such (FIGS. 3 and 4).

According to the invention, the two internal folds (a) and (b) of at least one of the gussets (1b) have arrangements suitable for forming, in combination with an added element (2), at least one handle (P). As indicated in the rest of the description, the added element (2) is fixed between the connecting zones (d) and (e).

The added element (2) has a substantially quadrangular planar shape. This element (2) may be prepared from the same material as the material of the bag or from another material, the only requirement being that this element must be weldable at the time of the continuous production of the bag, as indicated in the rest of the description.

In the embodiment shown in FIGS. 5, 9 and 10, the arrangements consist of openings (O1) and (O2) formed in the thickness of the folds (a) and (b) of the gusset (1b).

In order to maintain the seal inside the bag, the added element (2) is fixed on its four sides on the inside of the portion of the film (1) intended to form the gusset (1b). The element (2) is dimensioned to completely cover the openings (O2) and (O1). For example, the four sides of the element (2) are fastened by welding, the lateral edges of the element (2) being welded at the welds of the connecting zones (d) and (e).

The openings (O1) and (O2) have a generally substantially oblong shape and are disposed symmetrically on either side of the median line (c) of the two folds (a) and (b). These two openings (O1) and (O2) consequently bound a central strip which constitutes the handle as such (P), after having introduced at least one hand through the said openings (FIGS. 9 and 10).

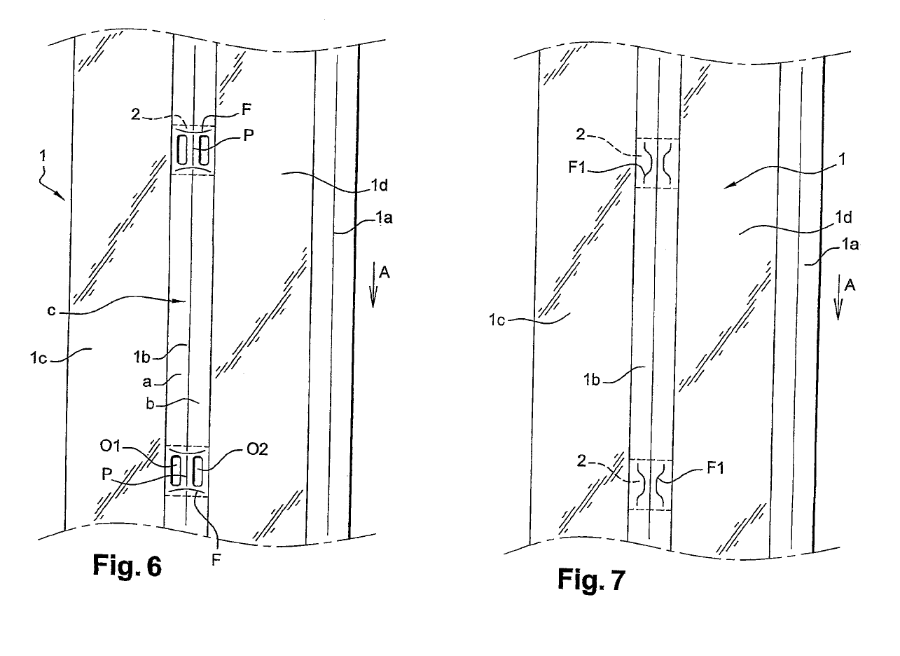

Based on this concept illustrated in FIGS. 5, 9 and 10, and to facilitate the formation of the handle (P), slits (F) may be formed transversally in the thickness of the folds (a) and (b) of the gusset (1b). These slits (F) are formed facing the added seal element (2), and on either side of the openings (O1) and (O2) (FIG. 6).

In the embodiment shown in FIG. 7, the arrangements consist of substantially omega shaped profiled slits (F1) and (F2) formed in the thickness of the folds (a) and (b) of the gussets (1b), facing the added seal element (2). These profiled slits (F1) and (F2) are formed symmetrically, on either side of the median line (c) of the two folds (a) and (b), while bounding, as previously, a central strip which constitutes the handle as such (P), after having introduced a hand through the said slits.

In the embodiments described above, the handle as such (P) resulting from the openings and/or slits, in combination with the added seal element (2), is formed directly from the material of the bag.

Importantly, in these embodiments, a reinforcing strip (3) is intended to be fixed in the zone of the gusset where the arrangements serving as a handle are formed. As stated above, the added seal element (2) is fixed facing this reinforcing strip (3) which has, in the same way as the folds of the gusset, openings (3a) and (3b) and/or slits.

In the embodiment shown in FIGS. 8 and 11, the added seal element (2) is fixed no longer inside, but to the outside of the folds (a) and (b). In this embodiment, the element (2) has slits or openings (2a) and (2b) formed symmetrically and on either side of its median line. These slits or openings (2a) and (2b) bound a central strip (2c) which constitutes the handle (P) as such, after having introduced a hand through the said slits or openings.

In this embodiment, the added element (2) is fixed only at its longitudinal sides (2d) close to the connecting zones (d) and (e).

It should be noted that in this embodiment, the element (2) does not participate directly in maintaining the seal inside the bag, since the openings or slits (2a) and (2b) for the passage of the hand are formed directly in the said element (2) and no longer in the thickness of the folds (a) and (b) of the gusset (1b).

Considering these various embodiments, to constitute arrangements serving as a handle, substantially in the median portion of at least one of the gussets of the bag, while continuing to maintain a perfect seal inside the bag, these various arrangements may be executed at the time of the continuous production of the bag and before the formation of the latter as such.

The invention also relates to the method for manufacturing a bag whereof one of the longitudinal gusset sides has, at the time of its design, arrangements suitable for serving as a handle.

As shown in particular in FIGS. 5, 6, 7 and 8, the various bags with gussets are obtained from a roll of a plastic film (F) which is continuously unwound, let (A) be the unwinding direction of the film (F). This film (F) is, in a manner perfectly known to a person skilled in the art, subjected to various operations to bound, between its two longitudinal sides (f1) and (f2), a portion constituting the front (1c) of the bag, a portion constituting one of the gussets (1b), a portion constituting the back (1d) of the bag and another portion constituting the other gusset (1a).

In the example illustrated, the portion constituting the gusset (1b) is subjected continuously, at regular intervals, to at least one operation for constituting the arrangements serving as a handle.

For example, if one considers the embodiments described above, the openings (O1) and (O2) are produced in the portion (1b), with, optionally, the slits (F) (or the slits (F1)), and then, in a second step, in the conditions described previously, that is, on the side of the film intended to constitute the interior of the film, the element (2) is added and fixed to completely cover the openings or slits in order to create a seal inside the bag, after the formation thereof.

It may be recalled that prior to the installation of the seal element (2), the zone of the gusset where the arrangements serving as a handle are to be formed, may advantageously be equipped with a reinforcing strip (3). In this case, the openings and/or slits are also formed in the thickness of this strip (3).

In the embodiment shown in FIG. 8, the element (2) having the openings or slits (2a) and (2b) is added and fastened, on the side of the film intended to constitute the exterior of the bag, on substantially the width of the portion (1b).

The film is then subjected to various operations of cutting, welding and bending, in order to produce, in a manner perfectly known to a person skilled in the art, a bag having a bottom, gussets and an opening.

It may also be recalled that after filling, for example, the bag is generally closed in a sealed manner, at its upper horizontal edge. Similarly, one of the walls, the face (1c) for example, may be equipped with a voluntary opening and closing system, of the “Zip® ” type, “Eclair® ” fastener, etc.

The advantages clearly appear from the description, in particular the following are emphasized and recalled:
the formation of arrangements serving as a handle, directly in at least one of the gussets constituting the longitudinal sides of the bag, while maintaining the seal inside the bag, and without being forced to prolong the height of the gusset concerned to form the handle;
the continuous production of the arrangements at the time of the formation of the bag on an automatic line and not after the formation of the bag as such;
the ease of execution;
the aesthetics;
in the folded storage position, or the filling position, the arrangements serving as a handle do not project beyond the bag and are completely integrated within the width of the gusset.

Obviously, without going beyond the scope of the invention, it is not inconceivable that the upper portion of the bag may continue to be arranged with means serving as a handle.

1. Plastic bag with gussets for food products, the gussets being formed at longitudinal sides of the bag and resulting from two internal folds formed from a median line and connecting, via connecting zones, a front and a back of the said bag, at least one of the said gussets having arrangements to serve as a handle, wherein the arrangements comprise openings formed in a thickness of the folds of the gusset, facing an added element which is fixed inside the folds of the gusset, in a sealed manner.

2. Bag according to claim 1, wherein the openings are formed substantially at mid-length of the gusset, facing the added element which is fixed between the connecting zones of the internal folds of the gusset with the front and back.

3. Bag according to claim 1, wherein the openings are formed in the thickness of the folds of the gusset and in a thickness of a reinforcing strip fixed substantially at mid-length of the gusset facing the added element which is fixed between the connecting zones of the internal folds of the gusset with the front and back.

4. Bag according to claims 1, wherein the openings have a substantially oblong general shape and are disposed symmetrically, on either side of the median line of the two folds, while bounding a central strip which constitutes the handle, after having introduced a hand through the said openings.

5. Bag according to claim 4, wherein profiled slits are formed transversally in the thickness of the folds of the gusset, facing the added element, and on either side of the openings.

6. Bag according to claim 3, wherein profiled slits are formed transversally in the thickness of the folds of the gusset, and in the thickness of the reinforcing strip, facing the added element and on either side of the openings.

7. Bag according to claim 1, wherein the openings comprise profiled slits formed in the thickness of the folds of the gusset, facing the added element which is fixed to the interior of the folds of the gusset, in a sealed manner, said slits being disposed symmetrically, on either side of the median line of the two folds, while bounding a central strip which constitutes the handle after having introduced a hand through the said slits.

8. Bag according to claim 1, wherein the openings comprise profiled slits formed in the thickness of the folds of the gusset and in the thickness of a reinforcing strip fixed facing the added element which is fixed inside the folds of the gusset, in a sealed manner, said slits being disposed symmetrically, on either side of the median line of the two folds, while bounding a central strip which constitutes the handle after having introduced a hand through the said slits.

9. Bag according to claims 1, wherein the added element has a substantially quadrangular planar shape.

10. Bag according to claim 9, wherein the substantially quadrangular planar shape is dimensioned to completely cover the openings in order to create a seal inside the bag.

11. Method for fabricating a plastic bag with gussets according to claim 1, comprising the following steps:
a roll of plastic film is unwound continuously, and subjected to operations to bound, between the two longitudinal edges of the film, a portion constituting the front of the bag, a portion constituting one of the gussets, a portion constituting the back of the bag, and another portion constituting an other of the gussets;
at regular intervals, one of the portions constituting one of the gussets, is continuously subjected to at least one operation for making openings to serve as a handle; and
the film is subjected to various operations of bending, cutting and welding, to produce a bag having a bottom, longitudinal sides with gussets and an opening.

12. Method according to claim 11, wherein:
openings are made in a thickness of the portion constituting one of the gussets for the passage of a hand, and disposed symmetrically on either side of a median line of said portion;
an element is added on and fastened, in a sealed manner and on a side of the film intended to constitute an interior of the bag, on substantially a width of the portion constituting one of the gussets, and at said openings, so as to close the openings fully.

13. Method according to claim 11, wherein:
a reinforcing strip is fixed at the openings serving as a handle;
openings are made in a thickness of the portion constituting one of the gussets and in a thickness of the added strip, for the passage of a hand, and disposed symmetrically on either side of a median line of the said portion;
an element is added on and fastened, in a sealed manner and on a side of the film intended to constitute an interior of the bag, on substantially a width of the portion constituting one of the gussets, and at said openings, so as to close the openings fully.
